(19) United States
(12) Patent Application Publication
(10) Pub. No.: US 2002/0181416 A1
(43) Pub. Date: Dec. 5, 2002

(54) Network system for transceiving various wireless network signals

(76) Inventors: Chung-Wang Lee, Hsinchu (TW); Tsai-Ching Chow, Hsinchu (TW)

Correspondence Address: BACON & THOMAS, PLLC, 625 SLATERS LANE, FOURTH FLOOR, ALEXANDRIA, VA, 22314

(21) Appl. No.: 09/870,491

(22) Filed: Jun. 1, 2001

(51) Int. Cl. H04Q 7/28

(52) U.S. Cl. 370/327; 370/338; 370/466; 370/401; 455/557

(57) ABSTRACT

A network system for transceiving various wireless network signals comprises wireless network signal transceivers, a router, and a wire connection for coupling the router to the wireless network signal transceivers and the router to Internet respectively; wherein each of the wireless network signal transceivers is operable to receive wireless packet messages sent from one of a variety of electronic devices having a wireless network adapter with a unique wireless communication protocol installed therein, determines the wireless communication protocol by reading the received wireless packet messages, decodes the wireless packet messages based on the associated wireless communication protocol, converts the same into wire packet messages having formats acceptable to the wire connection, sends the wire packet messages to the Internet through the wire connection and the router for effecting an exchange of packet message, receives the wire packet messages from the Internet through the wire connection, performs a respective conversion and encoding on the wire packet messages based on encoding rules of a variety of wireless network communication protocols stored therein, and transmits sequentially the converted and the decoded wireless packet messages to the electronic devices. Hence, the network system can successfully effect a wireless exchange of packet message with any wireless network adapter incorporating one of wireless network communication protocols.

### FIELD OF THE INVENTION

The present invention relates to networks and more particularly to a network system for transceiving various wireless network signals.

### BACKGROUND OF THE INVENTION

In recent years, the trend of computer design is ergonomic, compact, and even portable in brief. Further, how to increase the transmission speed between a computer and a peripheral device, and wiring elimination therebetween are important fields of development among computer manufacturers. Since 1995, PC95, PC98, and PC200 have been provided by Microsoft Corporation in which a wireless device has become a part of a standardized computer. It is understood that since Windows 95 operating system provided by Microsoft Corporation, there are more functions are incorporated in computer. For example, supports for multimedia device, the Internet, and plug and play which thereafter are standards for manufacturers in manufacturing computers. In addition, infrared transmission feature has been incorporated into a peripheral device. It is known that the transmission of infrared transmission is limited to one direction at one time. Also, infrared transmission is impossible in a poor lighting environment (for example the light of a fluorescent lamp is blocked by hand) or much weak if the device is at a distance about three to five meters. Hence, many researches have been made about the improvement of wireless network communication protocol so as to eliminate above problems associated with infrared transmission.

Currently, in a network system for transceiving wireless network signals, the communication thereof falls into one of three following types with respect to the specifications of wireless communication protocol:

(1) IEEE 802.11 B: This is a standard of IEEE 802 series specified by IEEE. A direct sequence is implemented for defining a local area network (LAN) in which wireless transmission is performed for effecting information communication. In other words, IEEE 802.11 protocol is a wireless LAN protocol. LAN signal defined by the protocol may travel up to 100 meter indoors or 300 meter outdoors. Also, a wide frequency band is available for connected devices. The transmission speed provided by the protocol is about 100 Base Ethernet.

(2) Bluetooth: This is developed by 3COM, Nokia, Ericsson, Motorola, IBM, Microsoft, and Sun as a wireless communication protocol in 1998. A frequency hopping is implemented for effecting a transmission medium between computer and a peripheral equipment. One of the most important advantages is that transmission distance and the number of connected devices are substantially unlimited. Hence, it is possible in the future for bluetooth to effect a wireless transmission between mobile phone and computer, mobile phone and handsfree device, or two different domestic appliances. Moreover, bluetooth may be utilized to effect a remote control for TV, air conditioner, Hi-Fi, or lamp.

(3) Home RF technique: A frequency hopping is also implemented. A network based domestic appliance may effect a wireless network connection for communicating information by utilizing RF signals provided by the home RF technique. In an operating environment of 2.4 GHz, the highest transmission rate is 1 mega bit per second. Similarly, one of the most important advantages is that frequency band limitation and the number of connected devices are substantially unlimited. Hence, the home RF technique is adopted by many electric product manufacturers for effecting a wireless transmission between mobile phone and computer, mobile phone and hands-free device, or two different domestic appliances.

IEEE 802.11 is advantageous over bluetooth and home RF technique in terms of long distance signal transmission, the number of connected devices, and fast transmission speed. But bluetooth and home RF technique are advantageous over IEEE 802.11 in terms of applications in domestic appliances, computers, computer peripheral devices, and even mobile phones. Hence, respective communication protocol is incorporated in domestic appliances, computers, computer peripheral devices, and mobile phones by the manufactures depending on applications. Since Industrial Scientific Medical (ISM) channel having 2.4 GHz is implemented in all wireless communication protocols, one of a variety of electric products incorporated with such wireless communication protocols may connect to the Internet in which a wireless network adapter is installed. In operation, wireless packet messages are transmitted depending on the used wireless communication protocol. Then a wireless network signal transceiver corresponding to the wire connection may receive the packet messages. Next, network applications, routing, and bridging features installed in the transceiver may be employed to perform a conversion between wireless packet messages and wire packet messages, route selection, and net address transfer (NAT), or the like.

However, prior art suffered from several disadvantages. For example, the network application can only receive wireless packet messages of IEEE 802.11 B protocol, or receive wireless packet messages of bluetooth and home RF technique. That is, the network application cannot receive wireless packet messages of IEEE 802.11 B protocol, bluetooth and home RF technique at the same time. Further, packet messages transmitted by one wireless communication protocol cannot convert into the other wireless communication protocol. Such incompatibility prevents one electronic device having accessing network capability from accessing one network system incorporating one of other wireless communication protocols. As a result, such electronic device is limited in applications, thus limiting its popularity among consumers.

Thus, it is desirable to provide an improved network system capable of transceiving various wireless network signals in order to overcome the above drawbacks of prior art.

### SUMMARY OF THE INVENTION

It is an object of the present invention to provide a network system for transceiving various wireless network signals comprising a plurality of wireless network signal transceivers, a router, and a wire connection for coupling the router to the wireless network signal transceivers and the router to Internet respectively; wherein each of the wireless network signal transceivers is operable to receive wireless packet messages sent from one of a variety of electronic devices having a wireless network adapter with a unique wireless communication protocol installed therein, determines the wireless communication protocol by reading the received wireless packet messages, decodes the wireless packet messages based on the associated wireless communication protocol, converts the same into wire packet messages having formats acceptable to the wire connection, sends the wire packet messages to the Internet through the wire connection and the router for effecting an exchange of packet message, receives the wire packet messages from the Internet through the wire connection, performs a respective conversion and encoding on the wire packet messages based on encoding rules of a variety of wireless network communication protocols stored therein, and transmits sequentially the converted and the decoded wireless packet messages to the electronic devices.

According to one aspect of the present invention, each of the wireless network signal transceiver comprises a wireless signal transceiver module for receiving the wireless packet messages sent from the wireless network adapters a plurality of wireless network interfaces each incorporating one of the wireless network communication protocols and coupled to the wireless signal transceiver module for receiving the wireless packet messages sent from the wireless signal transceiver module based on the incorporated the wireless network communication protocol; a memory for storing rules of the wireless network communication protocols and network applications; a central processing unit (CPU) for controlling the wireless network signal transceivers and decoding the received wireless packet messages based on the stored rules of the wireless network communication protocols; and a wire connection interface for performing a routing, a bridging, a route selection, and a net address transfer (NAT) on the received wireless packet messages based on the network applications stored in the memory, converting the received wireless packet messages into the wire packet messages acceptable to the wire connection, and transmitting the same to the Internet through the wire connection and the router.

According to one aspect of the present invention, each of the wireless network interfaces is operable to determine the wireless communication protocol used in transmitting the wireless packet messages, and delete the wireless packet messages if the determined wireless communication protocol is not one of the wireless network communication protocols or receive the wireless packet messages, and the CPU is operable to decode the wireless packet messages based on the wireless communication protocol used by the wireless packet messages and the rules of the wireless network communication protocols stored in the memory.

The above and other objects, features and advantages of the present invention will become apparent from the following detailed description taken with the accompanying drawings.

### BRIEF DESCRIPTION OF THE DRAWINGS

FIG. 1 is a schematic diagram of a network system for transceiving various wireless network signals according to the invention; and

FIG. 2 is a block diagram showing the components consisting wireless network signal transceiver of FIG. 1.

### DETAILED DESCRIPTION OF THE PREFERRED EMBODIMENTS

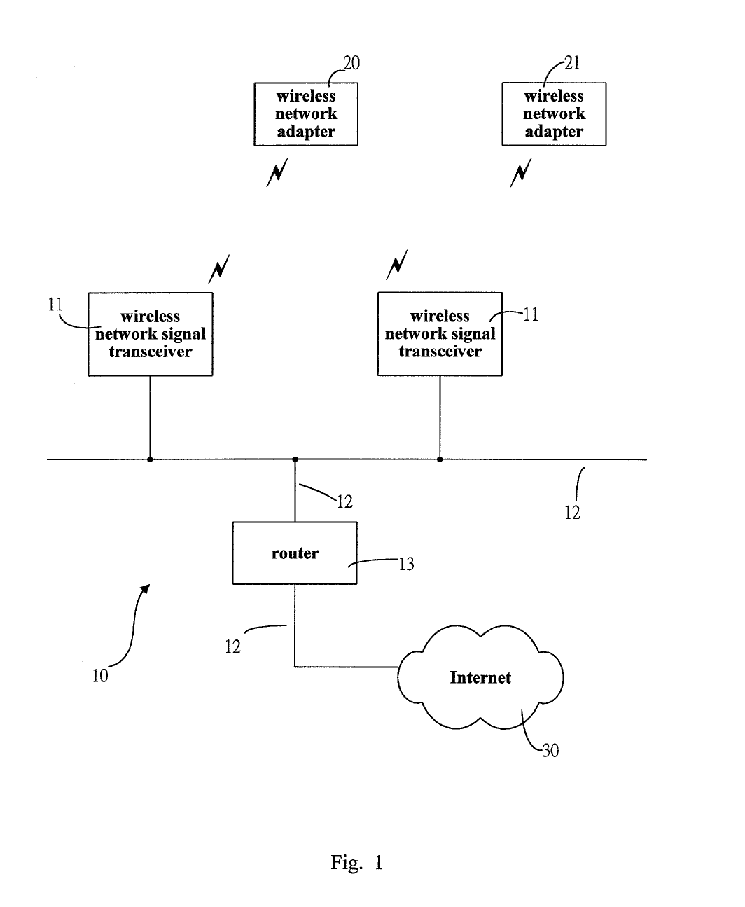

Referring to FIG. 1, there is shown a network system 10 in accordance with the invention comprising a plurality of wireless network signal transceivers 11 for receiving packet messages sent from various electronic devices (e.g., domestic appliances, computers, computer peripheral devices, and mobile phones). Each electronic device has a wireless network adapter 20 (or 21). Each of wireless network adapters 20 and 21 has its own wireless communication protocol (e.g., IEEE 802.11B, bluetooth, or home RF technique) depending on applications. Wireless network signal transceiver 11 can determine the wireless communication protocol by reading the received wireless packet messages. Then decode the packet messages based on the associated wireless communication protocol and convert the same into wire packet formats (e.g., IP packets) acceptable to wire connection 12. Then send wire packet messages to the Internet 30 through wire connection 12 and router 13 for effecting an exchange of packet message. Wireless network signal transceiver 11 may receive wire packet messages from the Internet 30 through wire connection 12. Then perform a respective conversion and encoding on the wire packet messages based on encoding rules of the various wireless network communication protocols stored therein. The converted and decoded wireless packet messages are transmitted sequentially. Hence, network system 10 may successfully effect a wireless exchange of packet message with any of wireless network adapter 20 or 21 incorporating one of wireless network communication protocols (e.g., IEEE 802.11B, bluetooth, or home RF technique).

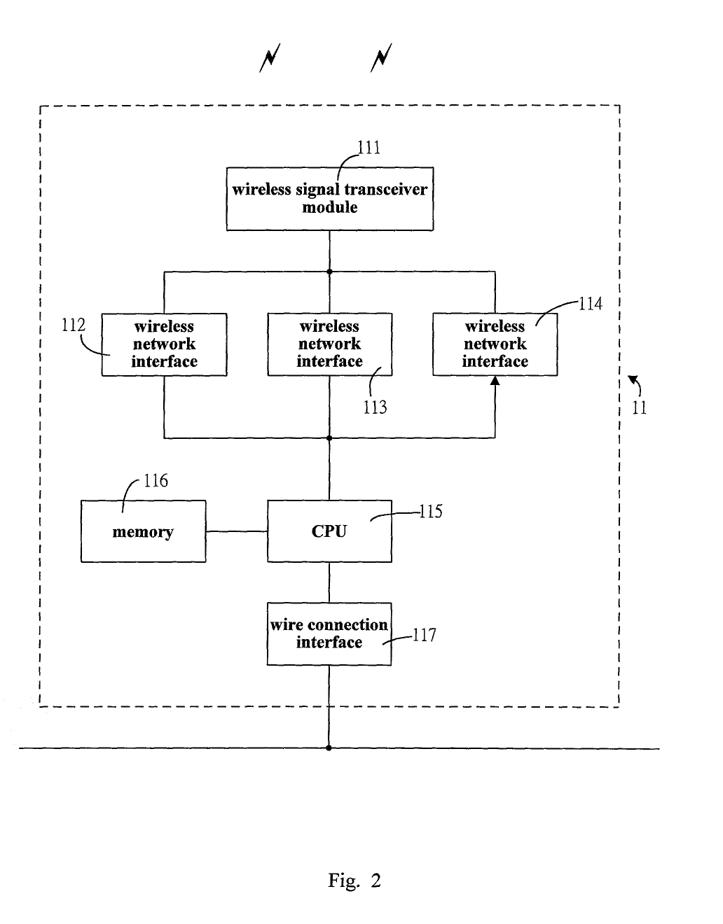

Referring to FIG. 2, wireless network signal transceiver 11 comprises a wireless signal transceiver module 111, a plurality of wireless network interfaces 112, 113, and 114 each incorporating one of wireless network communication protocols (e.g., IEEE 802.11B, bluetooth, or home RF technique), a central processing unit (CPU) 115, a memory 116, and a wire connection interface 117 in which wireless signal transceiver module 111 can receive wireless packet messages sent from wireless network adapter 20 or 21 and transmit the same to wireless network interfaces 112, 113 and 114. As such, wireless network interfaces 112, 113 and 114 may determine the wireless communication protocol used in transmitting the wireless packet messages. Further, the wireless packet messages are deleted if the determined wireless communication protocol is not one of the wireless network communication protocols. Otherwise, the wireless packet messages are received. CPU 15 then decode the wireless packet messages based on the wireless communication protocol used by the wireless packet messages and encoding rules of the various wireless network communication protocols stored in memory 116. CPU 115 also performs network applications, routing, bridging, route selection, and NAT features installed in wire connection interface 117 for converting the received wireless packet messages into wire packet messages (e.g., IP packets) acceptable to wire connection 12. As a result, an exchange of packet messages may be performed on the wire packet messages by accessing the Internet 30 through wire connection 12 and the router 13.

In brief, wireless network signal transceiver 11 may receive wire packet messages from the Internet 30 through wire connection 12 and wire connection interface 117. CPU 115 then may encode and convert the wire packet messages based on the various wireless network communication protocols stored in memory 116. CPU 115 also transforms the encoded and converted packet messages into various wireless packet messages through wireless network interfaces 112, 113 and 114. Then wireless signal transceiver module 111 may transmit the same sequentially. As a result, packet messages sent from the Internet 30 may successfully transmit to wireless network adapter 20 or 21 incorporating one of wireless network communication protocols.

While the invention has been described by means of specific embodiments, numerous modifications and variations could be made thereto by those skilled in the art without departing from the scope and spirit of the invention set forth in the claims.

What is claimed is:

1. A network system for transceiving various wireless network signals comprising:
at least one wireless network signal transceiver operable to receive wireless packet messages sent from one of a variety of electronic devices having a wireless network adapter with a unique wireless communication protocol installed therein;
a router; and
a wire connection for coupling said router to said wireless network signal transceiver and coupling said router to Internet respectively;
wherein said wireless network signal transceiver determines said wireless communication protocol while reading said received wireless packet messages, decodes said wireless packet messages based on said associated wireless communication protocol, converts said same into wire packet messages having formats acceptable to said wire connection, sends said wire packet messages to said Internet through said wire connection and said router for effecting an exchange of packet message, receives said wire packet messages from said Internet through said wire connection, performs a respective conversion and encoding on said wire packet messages based on encoding rules of a variety of wireless network communication protocols stored therein, and transmits sequentially said encoded and converted wireless packet messages to said wireless network adapters.

2. The network system of claim 1, wherein said wireless network signal transceiver comprises:
a wireless signal transceiver module for receiving said wireless packet messages sent from said wireless network adapters;
a plurality of wireless network interfaces each incorporating one of said wireless network communication protocols and coupled to said wireless signal transceiver module for receiving said wireless packet messages sent from said wireless signal transceiver module based on said incorporated said wireless network communication protocol;
a memory for storing rules of said wireless network communication protocols and network applications;
a central processing unit (CPU) for controlling said wireless network signal transceivers and decoding said received wireless packet messages based on said stored rules of said wireless network communication protocols; and
a wire connection interface for performing a routing, a bridging, a route selection, and a net address transfer (NAT) on said received wireless packet messages based on said network applications stored in said memory, converting said received wireless packet messages into said wire packet messages acceptable to said wire connection, and transmitting said same to said Internet through said wire connection and said router.

3. The network system of claim 2, wherein each of said wireless network interfaces is operable to determine said wireless communication protocol used in transmitting said wireless packet messages, and delete said wireless packet messages if said determined wireless communication protocol is not one of said wireless network communication protocols or receive said wireless packet messages, and said CPU is operable to decode said wireless packet messages based on said wireless communication protocol used by said wireless packet messages and said rules of said wireless network communication protocols stored in said memory.

4. The network system of any of claims 1 to 3, wherein each of said wireless network communication protocols is an IEEE 802.11B, a bluetooth, or a home RF technique.
